(19) United States
(12) Patent Application Publication
(10) Pub. No.: US 2008/0078676 A1
(43) Pub. Date: Apr. 3, 2008

(54) Biosensing device

(75) Inventors: Murphy Chiu, Hsinchu (TW); Wen Ching Yuan, Hsin-Chu City (TW)

Correspondence Address: BIRCH STEWART KOLASCH & BIRCH, PO BOX 747, FALLS CHURCH, VA, 22040-0747, US

(73) Assignee: EPS Bio Technology Corp.

(21) Appl. No.: 11/905,451

(22) Filed: Oct. 1, 2007

(30) Foreign Application Priority Data
Oct. 2, 2006 (TW) 095136493

(51) Int. Cl. G01N 27/28; B01J 19/00

(52) U.S. Cl. 204/403.01; 422/68.1

(57) ABSTRACT

A biosensing meter includes: a routing matrix including a plurality of switching units and a plurality of connecting ends; a sensors and actuators group, coupled to a plurality of connecting ends of the wire matrix; an RFID reader, for reading an RFID tag to obtain a parameter related to an application software, and a processing module, coupled to the switching units of the wire matrix and the RFID reader, the processing module including: a storage device, for storing the application software; and a processing unit, coupled to the storage device, for executing the application software according to the parameter to control the switching units to change the coupling condition between the sensors and actuators group and the processing module to measure a testing piece and obtain a measurement result.

### BACKGROUND OF THE INVENTION

1. Field of the Invention

The present invention relates to a biosensing device, and more particularly, to a biosensing device having an RFID device.

2. Description of the Related Art

In general, a biosensing device is utilized to measure the concentration of biological materials (for example, blood glucose concentration) in humans' blood. Therefore, a diabetic can monitor his blood glucose concentration by using the biosensing device to maintain his health.

U.S. Pat. No. 5,366,609 discloses a biosensing device, which utilizes a read-only-memory key (ROM key) to select a specific biosensing procedure to be executed or to provide parameters for biosensing procedures to achieve the purpose of measuring the concentration. For example, when different testing strips (testing samples) are plugged into the biosensing device, different ROM keys can be used to inform the biosensing device to execute a corresponding biosensing procedure according to different testing strips or to execute the biosensing procedure according to different parameters.

As mentioned previously, it can be seen that the above-mentioned biosensing device is flexible because it can utilize the ROM keys to adjust the procedure and the operation according to the selected procedure or the parameters. But this means the user has to carry the ROM key when the biosensing device is utilized. This restriction makes the user inconvenient.

Furthermore, the ROM key needs to output data through electrical contacts. That is, the user has to insert the ROM key into the biosensing device to obtain related parameters. Therefore, as time goes by, the ROM key may be abraded. In addition, in the actual usage, the user may accidentally break the ROM key, or incorrectly insert the ROM key (e.g: the ROM key may be inserted reversely). From the above disclosure, it can be seen that the ROM key is not a good solution for inputting data (parameters) into the biosensing device.

Furthermore, because the above-mentioned biosensing device utilizes the bus structure, this means all analog signals (including measurement results and temperature measurement results) have to be firstly converted into digital signals such that the microprocessor can deal with the digital-form measurement results and temperature measurement results. Therefore, in the above-mentioned structure, multiple ADCs should be converted into the biosensing device. This not only increases the cost, but also reduces the hardware flexibility.

### SUMMARY OF THE INVENTION

In view of the above-mentioned problems, an object of the invention is to provide a biosensing device having an RFID device, to utilize the RFID device to solve the above-mentioned problem.

According to an embodiment of the present invention, a biosensing device for performing a measurement operation on a testing strip to generate a measurement result is disclosed. The biosensing device comprises: a routing matrix, comprising a plurality of connecting ends and a plurality of switch devices; a sensors and actuators group, coupled to a plurality of connecting ends of the plurality of connecting ends of the routing matrix; an RFID reader, for reading an RFID tag to obtain at least one related parameter related to application software; and a processing module, coupled to the RFID reader and a plurality of connecting ends of the plurality of connecting ends of the routing matrix, the processing module comprises: a storage device storing the application software; and a processing unit, coupled to the storage device; for executing the application software according to the at least one parameter to control the plurality of switch devices inside the routing matrix to change electrical connections among the sensors and actuators group and the processing module such that the measuring operation is performed and the measurement result is obtained.

According to another embodiment of the present invention, a biosensing device for performing a measuring operation on a testing strip to generate a measurement result is disclosed. The biosensing device comprises: a bus; a sensors and actuators group, coupled to the bus; an RFID reader, for reading an RFID tag to obtain at least one parameter related to an application software; and a processing module, coupled to the bus and the RFID reader, the processing module comprises: a storage device storing the application software; and a processing unit, coupled to the storage device, for executing the application software according to the at least one parameter, obtained by the RFID reader, to control the sensors and actuators group to perform the measuring operation such that the measurement result is obtained.

The present invention biosensing device utilizes the RFID technique to replace the prior-art ROM key. This makes the user carry it more easily and use it more conveniently. Furthermore, in an embodiment of the present invention, the present invention utilize a routing matrix to replace the prior art bus structure. Therefore, the present invention can have better hardware flexibility and the hardware cost can be reduced.

### BRIEF DESCRIPTION OF THE DRAWINGS

FIG. 1 is a diagram of a biosensing device according to an embodiment of the present invention.

FIG. 2 is a circuit diagram of an embodiment of the routing matrix 130 shown in FIG. 1.

FIG. 3 is a diagram showing a blood glucose testing strip according to an embodiment of the present invention.

FIG. 4 is a diagram of a biosensing device according to another embodiment of the present invention.

### DETAILED DESCRIPTION OF THE INVENTION

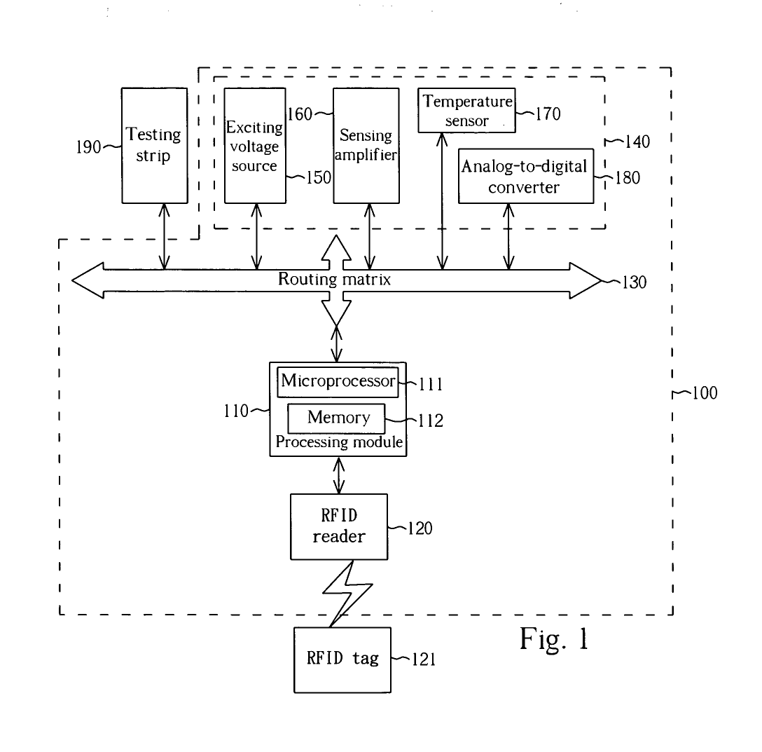

Please refer to FIG. 1, which is a diagram of a biosensing device 100 of a first embodiment according to the present invention. As shown in FIG. 1, the biosensing device 100 comprises a processing module 110, an RFID reader 120, a routing matrix 130, a sensors and actuators group 140. The sensors and actuators group 140 comprises an exciting voltage source 150, a sensing amplifier 160, a temperature sensor 170, and an analog-to-digital converter 180.

In addition, the processing module 110 comprises a microprocessor 111 and a memory 112 electrically connected to the microprocessor 111. The memory 112 stores application software. Furthermore, the RFID reader 120 is coupled to the processing module 110.

Please note that, the processing module 110, the exciting voltage source 150, the sensing amplifier 160, the temperature sensor 170, the A/D converter 180, and an under-test testing strip (biosensing sample) 190 to be measured are respectively electrically connected to the routing matrix 130. The operations and functions of the biosensing device 100 will be illustrated in the following disclosure.

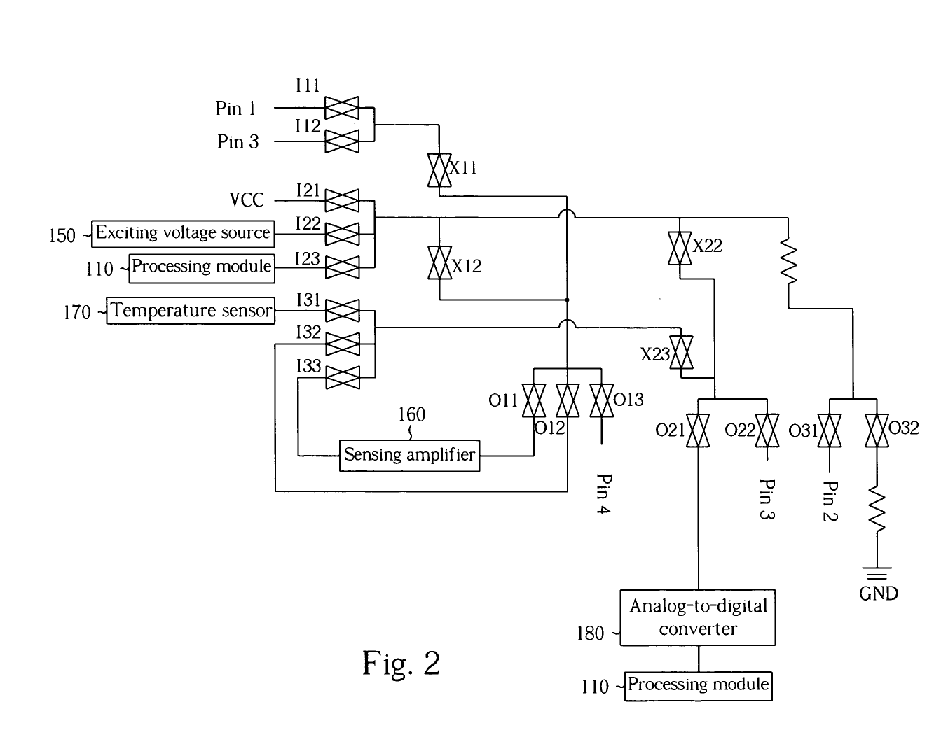

Please refer to FIG. 2, which is a circuit diagram of an embodiment of the routing matrix 130 shown in FIG. 1. As shown in FIG. 2, the routing matrix 130 comprises a plurality of transmission gates I11-I33, X11-X23, and O11-O32, and a plurality of connecting ends. The connecting ends are respectively electrically connected to the above-mentioned inner devices and the pins 1-4 of the testing strip 190. It should be noticed that, the electrical connections among the devices and the routing matrix 130 are shown in FIG. 2, and further illustrations are thus omitted here.

From FIG. 2, it can be seen that the routing matrix 130 can change the circuit configuration (change the electrical connections among the inner devices of the biosensing device 100) according to the conditions of each of the transmission gates I11-I33, X11-X23, and O11-O32. In this embodiment, the microprocessor 111 is coupled to each of the transmission gates I11-I33, X11-X23, and O11-O32 (not shown). Therefore, when the microprocessor 111 executes the application software inside the memory 112, the microprocessor 111 is able to control the conducting condition of each transmission gate in order to further control the circuit configuration of the entire routing matrix 130 such that the biosensing device 190 can perform a measuring operation on the testing strip 190.

Please note that, the RFID reader 120 is utilized to read an RFID tag 121 and obtain parameters related to the application software (for example, the parameters can be utilized to call a certain sub-program) from the RFID tag 121. In this way, the microprocessor 111 can perform a specific measuring operation corresponding to a specific testing strip 190. Or, the microprocessor 111 can use specific parameters corresponding to a specific testing strip 190 to perform the same measuring operation. In this embodiment, the RFID tag 121 can be embedded in the testing strip 190, or can be manufactured as an independent identification card for the RFID reader 120 to read.

For example, assume that the biosensing device 100 supports different types of testing strips (for example, the blood glucose testing strip, the uric acid testing strip, etc.). Therefore, if a user wants to measure the blood glucose, the biosensing device 100 (microprocessor 111) has to know that the currently-used testing strip is a blood glucose testing strip such that a corresponding blood glucose measurement operation can be performed correctly. In this embodiment, the RFID reader 120 can read the RFID tag 121 (as mentioned previously, it can be embedded in the blood glucose testing strip) and transfer the read information to the microprocessor 111. The microprocessor 111 therefore knows the type of the currently-used testing strip from the information transferred from the RFID reader 120. In this way, the microprocessor 121 can perform related software program related to the blood glucose measurement.

Surely, besides the above-mentioned mechanism, the microprocessor 111 may firstly store the information (such as the above-mentioned parameters), which the RFID reader 120 reads from the RFID tag 121, inside the memory 112 and use the stored information when the application software is executed. This mechanism is good because the biosensing device 100 does not have to repeatedly read the information from the RFID tag. Instead, the microprocessor 111 can directly read the needed information from the memory 112. This really improves the efficiency of the biosensing device 100.

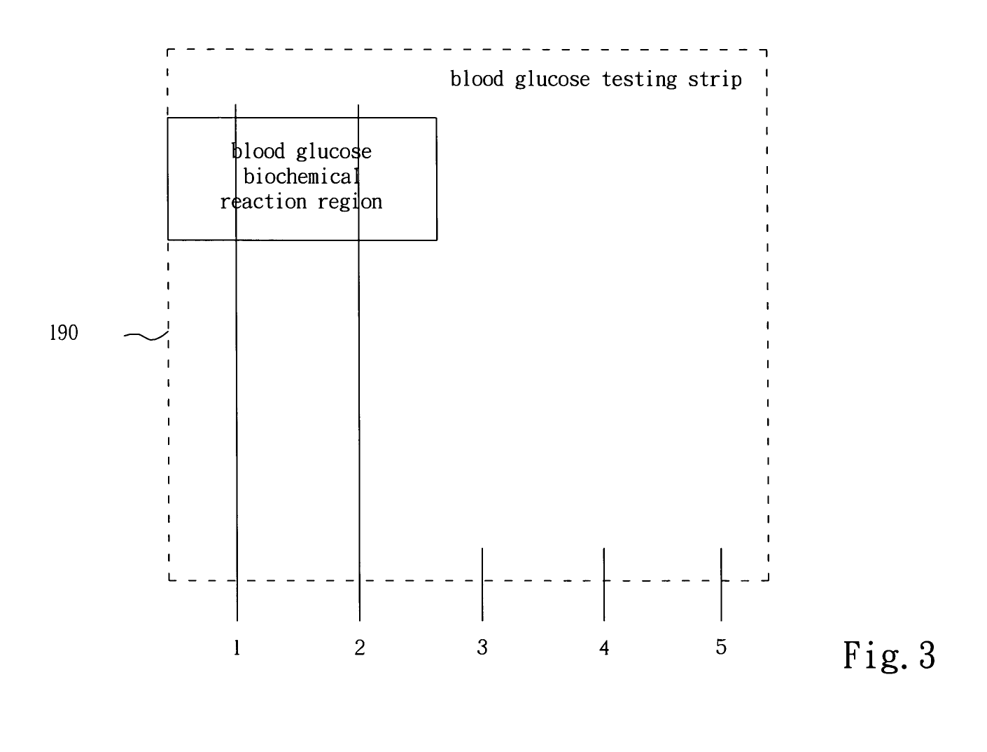

Please refer to FIG. 3, which is a diagram showing a blood glucose testing strip 190 according to an embodiment of the present invention. The microprocessor 111 can perform application software stored inside the memory 112 according to the information stored inside the RFID tag (as mentioned previously, the information can be transferred from the RFID reader 120 which reads the RFID tag 121, or previously stored inside the memory 112) to perform the following steps: First, the microprocessor 111 turns on the transmission gates I21, X22, and O21 to check whether the external voltage source (such as a battery voltage) Vcc is normal. And then, the microprocessor 111 turns on the transmission gate 122 for setting the voltage level provided by the exciting voltage source 150 to ensure that the voltage level is workable for the following electronic chemical reaction of the testing strip 190. Then, the microprocessor 111 turns on the transmission gates I11, I22, I33, X11, X23, O11, O31 and determines the gain value of the sensing amplifier 160 such that the voltage level provided by the exciting voltage source 150 can be transferred to the pins 1-2 of the testing strip 340. In this way, the testing strip 190 can start an electronic chemical reaction and generate a reaction result. The reaction result is amplified by the sensing amplifier 160 to generate an amplified signal. The A/D converter 180 transforms the amplified signal into a digital signal for the microprocessor 111 to process. At last, the microprocessor 111 turns on the transmission gates I31, X23, and O21 to utilize the temperature sensor 170 to detect the environment temperature and utilize the A/D converter 180 to transform the detection result of the temperature sensor into a digital temperature signal. Therefore, the microprocessor 111 can process the digital signal and the digital temperature signal to obtain a final measurement result of the blood glucose.

As mentioned previously, because each of the transmission gates inside the routing matrix 130 can be turned on/off (switched) according to different circuit demands, the inner devices of the biosensing device 100 can have different combination (configurations) such that the biosensing device can have a better hardware flexibility. For example, the above-mentioned sensing amplifier 160 and the temperature sensor 170 can share the same A/D converter 180 by switching the inner transmission gates inside the routing matrix 130.

In addition, the present invention utilizes the RFID techniques to replace the conventional ROM key. The RFID tag can be embedded in the testing strip or the container of the testing strips. This could make the user much easier to carry the RFID tag. In addition, as long as the RFID tag lies in a predetermined range of the RFID reader, the RFID reader is able to derive information from the RFID tag. Therefore, the present invention biosensing device 100 is more convenient to use.

Please note, in this embodiment, the present invention does not limit the type of the memory 112. For example, the memory 112 can be implemented with ROM, PROM, EPROM, or RAM.

Furthermore, the routing matrix 200 is only regarded as an embodiment, not a limitation of the present invention. In the actual implementation, the present invention can utilize any other programmable routing matrix to control the circuit configuration of every component inside the biosensing device 100. This also obeys the spirit of the present invention. For example, the transmission gates inside the routing matrix are used as a switch. Therefore, the transmission gate can be replaced by a switch or transistor. Moreover, the circuit path can be implemented with jumping wires or fixed wires.

Furthermore, the present invention does not limit the position of the RFID tag. In the actual implementation, the RFID tag can be placed in every possible position as long as it can be correctly read by the RFID reader 120. For example, it can be embedded inside the testing strip or an independent card. These changes belong to the scope of the present invention.

Moreover, how to store information inside the RFID tag has been known by those having average skills in the art. For example, in the standard (ISO15696 or ISO18000) of the RFID tag, some reservation fields are not utilized. Therefore, the reservation fields can be utilized to record the above-mentioned information (parameters).

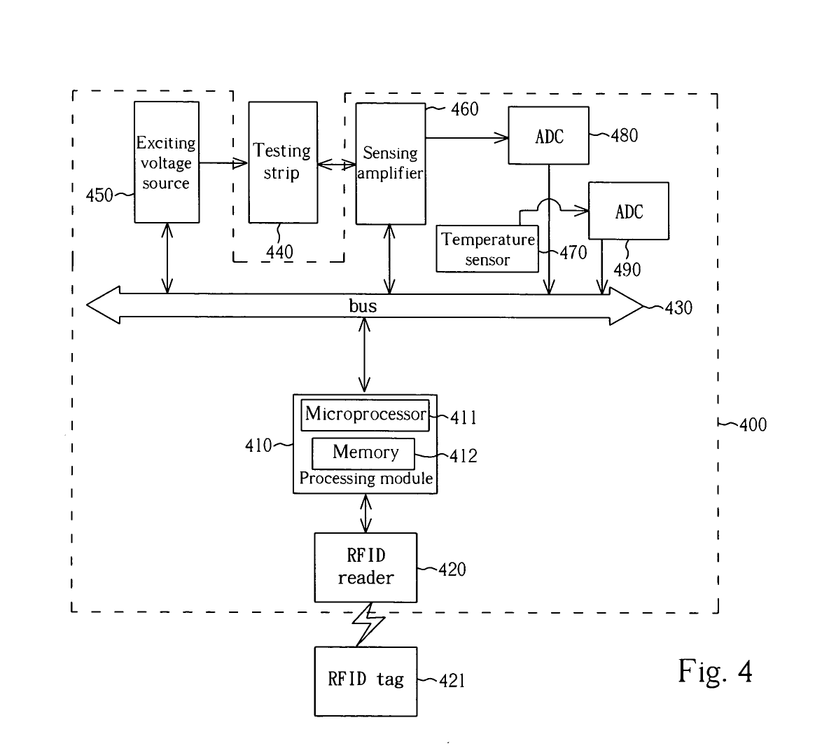

Please refer to FIG. 4, which is a diagram of a biosensing device 400 according to a second embodiment of the present invention. As shown in FIG. 4, the biosensing device 400 comprises a processing module 410, an RFID reader 420, a bus 430, an excitation voltage source 450, a sensing amplifier 460, a temperature sensor 470, and two ADCs 480 and 490.

In this embodiment, the processing module 410 comprises a microprocessor 411 and a memory 412, where the memory 412 is coupled to the microprocessor 411. The memory 412 stores application software. Furthermore, the processing module 410 communicates with the excitation voltage source 450 and the ADCs 480 and 490 via the bus 430. In addition, the RFID reader 410 is coupled to the processing module 410.

Please note, in this embodiment, the biosensing device 400 is similar than a conventional biosensing device. The difference between them is the biosensing device 400 comprises an RFID reader 420 for reading information from an RFID tag 421 which is used for the microprocessor 411 to execute the application software.

Similarly, the microprocessor 411 may firstly store the information (such as the above-mentioned parameters), which the RFID reader 420 reads from the RFID tag 421, inside the memory 412 and use the stored information when the application software is executed. The advantage of this mechanism has been illustrated in the above disclosure and thus omitted here.

The operation of the biosensing device 400 is similar to the biosensing device 100. Similarly, the microprocessor 411 can perform application software stored inside the memory 412 according to the information stored inside the RFID tag 421 (as mentioned previously, the information can be transferred from the RFID reader 420 which reads the RFID tag 421, or previously stored inside the memory 412) to perform the following steps: First, the microprocessor 411 sets the voltage level provided by the exciting voltage source 450 via the bus 430 to ensure that the voltage level is workable for the following electronic chemical reaction of the testing strip 440. Then, the testing strip 440 can start an electronic chemical reaction and generate a reaction result. The reaction result is amplified by the sensing amplifier 460 to generate an amplified signal. The A/D converter 480 transforms the amplified signal into a digital signal. At last, the temperature sensor 170 detects the environment temperature and the A/D converter 490 transforms the detection result of the temperature sensor into a digital temperature signal. Therefore, the microprocessor 411 can obtain the digital signal and digital temperature signal outputted from the ADCs 480 and 490 via the bus 430 and obtain a final measurement result of the blood glucose.

Please note, the biosensing device 400 use the bus mechanism. Therefore, it doesn't have the same flexibility as the biosensing device 400 using the routing matrix. Therefore, in this embodiment, the biosensing device 400 should utilize two ADCs to respectively convert the signals outputted from the sensing amplifier 460 and the temperature sensor 470 into digital signals for the microprocessor 411 to process.

However, in this embodiment, the RFID techniques are utilized to replace the ROM key. As mentioned previously, the RFID tag is easier to use such that the biosensing device 400 is easier to use.

Furthermore, the present invention does not limit the position of the RFID tag. In the actual implementation, the RFID tag can be placed in every possible position as long as it can be correctly read by the RFID reader 420. For example, it can be embedded inside the testing strip or an independent card. These changes belong to the scope of the present invention.

Please note, in this embodiment, the present invention does not limit the type of the memory 412. For example, the memory 412 can be implemented with ROM, PROM, EPROM, or RAM.

The present invention biosensing device utilizes the RFID technique to replace the prior-art ROM key. This makes the user carry it more easily and use it more conveniently. Furthermore, in an embodiment of the present invention, the present invention utilize a routing matrix to replace the prior art bus structure. Therefore, the present invention can have better hardware flexibility and the hardware cost can be reduced.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. A biosensing device, for performing a measurement operation on a testing strip to generate a measurement result, the biosensing device comprising:
a routing matrix, comprising a plurality of connecting ends and a plurality of switch devices;
a sensors and actuators group, coupled to a plurality of connecting ends of the plurality of connecting ends of the routing matrix;
an RFID reader, for reading an RFID tag to obtain at least one related parameter related to application software; and
a processing module, coupled to the RFID reader and a plurality of connecting ends of the plurality of connecting ends of the routing matrix, the processing module comprising:
a storage device storing the application software; and
a processing unit, coupled to the storage device; for executing the application software according to the at least one parameter to control the plurality of switch devices inside the routing matrix to change electrical connections among the sensors and actuators group and the processing module such that the measuring operation is performed and the measurement result is obtained.

2. The biosensing device of claim 1, wherein the sensors and actuators group comprises an exciting voltage source, a sensing amplifier, a temperature sensor, and an analog-to-digital converter, respectively electrically connected to the connecting ends of the routing matrix; wherein the processing unit executes the application software according to the at least one parameter, obtained by the RFID reader, to control the exciting voltage source to trigger a testing strip to generate a reaction result, to control the sensing amplifier and the analog-to-digital converter to transform the reaction result into a digital signal, to control the temperature sensor and the analog-to-digital converter to generate a digital temperature signal, and to process the digital signal and the digital temperature signal to generate the measurement result.

3. The biosensing device of claim 1, wherein the processing unit is a microprocessor.

4. The biosensing device of claim 1, wherein the storage device is a memory.

5. The biosensing device of claim 4, wherein the memory is a read-only memory (ROM) or a random access memory (RAM).

6. The biosensing device of claim 1, wherein the routing matrix comprises a fixed circuit.

7. The biosensing device of claim 1, wherein the routing matrix is implemented by jumper wires.

8. The biosensing device of claim 1, wherein the routing matrix is a programmable routing matrix.

9. The biosensing device of claim 1, wherein the switch devices are capable of being implemented by transistors, transmission gates, or relays.

10. The biosensing device of claim 1, wherein the RFID tag is embedded inside the testing strip.

11. The biosensing device of claim 1, wherein the RFID tag is in an independent identification card.

12. The biosensing device of claim 1, wherein the processing unit further stores the at least one parameter obtained by the RFID reader into the storage device and executes the application software according to the at least one parameter stored inside the storage device.

13. A biosensing device for performing a measuring operation on a testing strip to generate a measurement result, the biosensing device comprising:
a bus;
a sensors and actuators group, coupled to the bus;
an RFID reader, for reading an RFID tag to obtain at least one parameter related to an application software; and
a processing module, coupled to the bus and the RFID reader, the processing module comprising:
a storage device storing the application software; and
a processing unit, coupled to the storage device, for executing the application software according to the at least one parameter, obtained by the RFID reader, to control the sensors and actuators group to perform the measuring operation such that the measurement result is obtained.

14. The biosensing device of claim 13, wherein the sensors and actuators group comprises:
an exciting voltage source, coupled to the biosensing strip and the bus;
a sensing amplifier, coupled to the biosensing strip, for sensing a reaction result of the testing strip;
a temperature sensor, for sensing surrounding temperature and generating a temperature sensing result;
a first analog-to-digital converter, coupled to the sensing amplifier and the bus, for converting the reaction result into digital data; and
a second analog-to-digital converter, coupled to the temperature sensor, for converting the temperature sensing result into digital temperature data;
wherein the processing unit executes the application software according to the at least one parameter of the RFID reader to control the exciting voltage source to trigger a testing strip to generate a reaction result, to receive the digital data and the digital temperature data from the bus to perform a calculation on the digital data and the digital temperature data such that the measurement result is generated.

15. The biosensing device of claim 13, wherein the processing unit is a microprocessor.

16. The biosensing device of claim 13, wherein the storage device is a memory.

17. The biosensing device of claim 16, wherein the memory is a read-only memory (ROM) or a random access memory (RAM).

18. The biosensing device of claim 13, wherein the RFID tag is embedded inside the testing strip.

19. The biosensing device of claim 13, wherein the RFID tag is in an independent identification card.

20. The biosensing device of claim 13, wherein the processing unit further stores the at least one parameter obtained by the RFID reader into the storage device and executes the application software according to the at least one parameter stored inside the storage device.
